(19) United States
(12) Patent Application Publication
(10) Pub. No.: US 2011/0189466 A1
(43) Pub. Date: Aug. 4, 2011

(54) PLASMA SPRAY PROCESS AND PRODUCTS FORMED THEREBY

(75) Inventors: Silvan Jaggi, Lostorf (CH); Tamara Wippich, Schofflisdorf (CH); Vinzenz Max Frauchiger, Solosthurn (CH)

(73) Assignee: SMITH & NEPHEW ORTHOPAEDICS AG, Memphis, TN (US)

(21) Appl. No.: 13/122,318

(22) PCT Filed: Oct. 5, 2009
(86) PCT No.: PCT/EP2009/007115

§ 371 Date: Apr. 1, 2011

(30) Foreign Application Priority Data
Oct. 3, 2008 (GB) 0818156.2

(51) Int. Cl. B32B 3/26; C23C 4/12; C23C 4/10; C23C 4/06

(52) U.S. Cl. 428/304.4; 427/446; 427/453; 427/455

(57) ABSTRACT

A plasma spray process, comprising the following steps: providing a first material; providing a second material; providing a plasma source; and introducing the first and second materials into the plasma source in order to produce a plasma spray, wherein the second material at least partially melts in the plasma and binds the first material. A composition of matter formed by such a process. A substrate modified by such a process.

The present invention relates to a plasma spray process and products formed thereby. In particular, the present invention relates to a plasma spray process for forming open porous surface structures. The process of the present invention may be used to produce medical devices, particularly implants, and especially those that may be used for cement-less fixation.

In the past, two types of systems have been developed for successful cementless implant fixation. The first type of system enables bone to grow directly onto the surface. Typical examples of the first technology are titanium vacuum plasma spray (VPS) coatings which exhibit a very rough surface structure. Bone tissue grows directly onto this kind of surface.

The second type of system enables bone to grow into the surface. A typical example of the second technology is an open porous surface with sintered CoCr beads. The bone can grow into the 3D structure but will not directly bind to the CoCr beads.

In order to improve the connection between tissue and artificial surface further, combinations of both structures allowing for bone on- and in-growth have been developed. For example, tantalum metal may be deposited on a pyrolytic carbon scaffold using a chemical vapour deposition (CVD) technique. Alternatively, such open-porous structures may be made by using a polymeric scaffold (for example comprising polyurethanes) that is coated with metal particles, and subsequently sintered in a vacuum furnace. Upon sintering, the polymeric structure should evaporate completely.

These open-porous structures/coatings have a number of significant disadvantages. The manufacturing costs are high compared to conventional implant surfaces. Furthermore, the polymeric structures used (e.g. polyurethanes) can, upon incomplete thermal decomposition, result in toxic residues which can remain in the coating.

Another method of forming rough titanium coatings having an open-porous coating structure involves a modified VPS process.

A mono-disperse commercially pure titanium powder (size distribution: 90-250 μm) with minor additions of silicon (sinter aid, 1% by mass) may be used to form a coating. By way of comparison, standard VPS has a size distribution less than 150 μm (usually in the range 50-150 μm) and does not use silicon as a sinter aid. In modified VPS, the sintering aid is mechanically alloyed to the surface of the titanium particles to lower their surface melting temperature. This potentially forms Si/Ti-eutectics at various compositions. The coating is applied to metal implant surfaces (CoCrMo, titanium/alloys, zirconium/alloys) using the VPS process.

However, such modified VPS processes for forming open porous structures have disadvantages. The commercially pure titanium powder which is used for the VPS process has to be pre-treated in order to mechanically alloy the sinter aid (silicon) to the particle surface. This additional pre-treatment increases the manufacturing costs. Furthermore, the thorough control of the process environment is very difficult. It is not desirable to introduce a sinter aid such as silicon into the process. This raises the manufacturing costs. Furthermore, the addition of a sinter aid like silicon changes the surface chemical composition of the implant.

According to a first aspect of the present invention, there is provided a plasma spray process, comprising the following steps:
providing a first material;
providing a second material;
providing a plasma source; and
introducing the first and second materials into the plasma source in order to produce a plasma spray,
wherein the second material at least partially melts in the plasma and binds the first material.

The second material may fully melt in the plasma.

The first material may partially melt in the plasma.

According to some embodiments of the present invention, the first material does not melt in the plasma.

According to some embodiments of the present invention, the process comprises providing more than two materials.

According to some embodiments of the present invention, at least one of the materials at least partially melts in the plasma and binds at least one of the other materials.

According to some embodiments of the present invention, at least one of the materials fully melts in the plasma and binds at least one of the other materials.

At least one of the materials may comprise discrete particles.

At least one of the materials may be a powder.

According to a second aspect of the present invention, there is provided a plasma spray process, comprising the following steps:
providing a first powder;
providing a second powder;
providing a plasma source; and
introducing the first and second powders into the plasma in order to generate a plasma spray,
wherein the first powder comprises particles that tend not to fuse with each other, and the second powder comprises particles that tend to fuse with each other.

The first powder may comprise particles that do not fuse with each other.

The second powder may comprise particles that fuse with each other.

The second powder may comprise particles that fuse with the first powder particles.

According to a third aspect of the present invention, there is provided a plasma spray process, comprising the following steps:
providing a first powder;
providing a second powder;
providing a plasma source; and
introducing the first and second powders into the plasma in order to generate a plasma spray,
wherein the first powder comprises particles that tend not to melt within the plasma, and the second powder comprises particles that tend to melt within the plasma.

The second powder particles that melt may bind the first powder particles.

The first powder may comprise particles that do not melt.

The second powder may comprise particles that all melt within the plasma.

According to a fourth aspect of the present invention, there is provided a plasma spray process, comprising the following steps:
providing a first powder fraction having a first particle size distribution;
providing a second powder fraction having a second particle size distribution;
providing a plasma source; and
introducing the first and second powder fractions into the plasma in order to generate a plasma spray,
wherein the first particle size distribution is greater than the second particle size distribution.

According to a fifth aspect of the present invention, there is provided a plasma spray process, comprising the following steps:
providing a first powder fraction having a first particle size distribution;
providing a second powder fraction having a second particle size distribution;
providing a plasma source; and
introducing the first and second powder fractions into the plasma in order to generate a plasma spray,
wherein the mean particle size of the first powder is greater than the mean particle size of the second powder.

According to some embodiments of the present invention, the process further comprises the steps of:
providing a substrate; and
exposing the substrate to the plasma spray in order to form an open porous structure on the substrate.

The substrate may be selected from the group consisting of metal, metal alloy, ceramic, polymer, or combinations thereof.

The substrate may be selected from the group consisting of titanium, titanium alloy, cobalt chromium alloy, zirconium, zirconium alloy, magnesium, magnesium alloy, tantalum, tantalum alloy, hafnium, hafnium alloy, niobium, niobium alloy, stainless steel, ultra-high molecular weight polyethylene (UHMWPE), polyaryletheretherketone (PEEK), polyaryletherketone (PAEK), polyetherketoneketone (PEKK) or combinations thereof.

The process may further comprise the step of applying a transfer arc between the substrate and the plasma source.

The process may further comprise the step of applying an intermediate layer between the substrate and the open porous structure.

The intermediate layer may comprise a material selected from the group consisting of titanium, titanium alloy, cobalt chromium alloy, zirconium, zirconium alloy, magnesium, magnesium alloy, stainless steel, ultra-high molecular weight polyethylene (UHMWPE), polyaryletheretherketone (PEEK), polyaryletherketone (PAEK), polyetherketoneketone (PEKK) or combinations thereof.

The first powder may comprise coarse particles and the second powder may comprise fine particles.

The first powder particle size distribution may be in the range 150-800 μm.

The first powder particle size distribution may be in the range 180-500 μm.

The first powder particle size distribution may be in the range 200-350 μm.

The second powder particle size distribution may be in the range 30-250 μm.

The second powder particle size distribution may be in the range 45-200 μm.

The second powder particle size distribution may be in the range 75-200 μm.

The second powder particle size distribution may be in the range 100-200 μm.

The second powder particle size distribution may be in the range 125-200 μm.

The second powder particle size distribution may be in the range 150-200 μm.

The size and chemical make-up of the coarse powder may be tailored to achieve a resulting product similar to a sintered asymmetric particle porous structure such as a STIKTITE porous coating (Smith & Nephew) by a plasma-spray process.

According to some embodiments of the present invention, the procesS may comprise more than two powders.

At least two of the powders may have a different particle size distribution.

Each powder may have a different particle size distribution.

At least two of the powders or materials may have a different chemical composition.

For example, three different powder fractions may be used instead of two. The three different fractions may be separately injected into the plasma torch. The different fractions may have the variations described herein.

The powders or materials may be selected from the group consisting of metal, metal alloy, ceramic, polymer, or combinations thereof.

The powders or materials may be selected from the group consisting of titanium, titanium alloy, zirconium, zirconium alloy, magnesium, magnesium alloy, zinc, zinc alloy, tantalum or combinations thereof.

Titanium alloy (Ti 6Al 4V or Ti 6Al 7Nb, etc.) powders may be used instead of commercially pure titanium.

Powders with differing chemical compositions may be used. For example, commercially pure titanium fine powder and titanium alloy coarse powder.

Zirconium or zirconium alloy powders may be used.

Magnesium or magnesium alloy powders may be used.

A combination of titanium or titanium alloy or zirconium or zirconium alloy powders as coarse fraction and silicon powder as fine fraction may be used.

Commercially pure titanium powder as a coarse fraction and titanium hydride powder as fine fraction may be used.

Titanium or titanium alloy powder or zirconium or zirconium alloy powder in combination with a resorbable metal (for example, magnesium, magnesium alloy, zinc, or zinc alloy) powder may be used to enable resorption of the resorbable metal.

An inert bioceramic powder (for example, alumina, zirconia, or silicon nitride) in combination with a resorbable magnesium- or zinc-based powder or a resorbable calcium phosphate-based powder may be used.

Non-metallic (inorganic) powders in combination with metallic powders for the creation of a coating with bio-resorbable fractions may be used. For example, brushite/plaster of Paris in combination with commercially pure titanium or zirconium (alloy).

Non-metallic (inorganic) powders in combination with metallic powders for the creation of a coating with bio-resorbable fractions where the bio-resorbable fraction contains an anti-microbial constituent like silver or zinc may be used.

Non-metallic (inorganic) powders in combination with metallic powders for the creation of a coating with bio-resorbable fractions where the bio-resorbable fraction contains a constituent facilitating osteointegration, such as strontium, magnesium or fluoride may be used.

At least two of the powders or materials may be introduced simultaneously.

At least two of the powders or materials may be introduced sequentially.

Sequential application of the different powder fractions may enable the formation of an intermediate layer to tune the properties of the generated structure.

The plasma source may be a plasma torch.

Different types of plasma nozzle design may be used to modify the plasma shape and the particle flow through the torch.

The plasma spray process may occur in vacuum.

The plasma spray process may occur in an inert atmosphere.

The inert atmosphere may comprise argon.

The inert atmosphere may comprise helium.

The inert atmosphere may comprise nitrogen.

The chamber pressure may be in the range 400 mbar-atmospheric pressure.

The chamber pressure may be in the range 500 mbar-atmospheric.

The chamber pressure may be in the range 500-800 mbar.

The chamber pressure may be in the range 550-750 mbar.

The plasma forming gases may be selected from the group consisting of argon, helium, hydrogen, nitrogen, or combinations thereof.

The plasma gas mixtures may be varied. For example, hydrogen or nitrogen may be added to an argon/helium mixture.

An argon/hydrogen mixture may be used to increase the plasma temperature.

The plasma forming gases may comprise argon and helium having a flow rate in the range 40-80 l/min.

The plasma forming gases may comprise argon and helium and the argon/helium ratio may be in the range 0.6-0.8 for the plasma gas.

The powders or materials may be introduced into the plasma by a carrier gas.

The different powders or materials may be introduced into the plasma by different carrier gases. This may enable different temperatures locally.

The carrier gas flow rates may be different for the different powders or materials.

The process may further comprise the step of mixing the materials or powders in situ prior to their introduction into the plasma.

The process may further comprise not pre-mixing the materials or powders in order to have a defined but variable fine/coarse powder ratio in the coating (i.e. avoid de-mixing during storage).

The process may further comprise a device disposed in the powder feed lines to pulse the powder flow. That is, rather than a continuous flow of powder, the powder may be fed in discrete pulses.

At least one of the powders or materials may be electrically conductive and an arc may be generated between the substrate and a counter electrode.

The transfer arc current may be in the range 0-200 A.

The plasma generating current may be in the range 900-1300 A.

The ratio between coarse and fine powder may be in the range 1/4-1/2.

The distance between the plasma source (gun, torch) and the substrate during the coating process may be in the range 145-205 mm. This is referred to as the stand-off distance.

According to a sixth aspect of the present invention, there is provided a composition of matter formed according to any of the processes defined by any of the first to fifth aspects of the present invention.

According to a seventh aspect of the present invention, there is provided a substrate modified by any of the processes defined by any of the first to fifth aspects of the present invention.

According to an eighth aspect of the present invention, there is provided a medical device comprising a substrate according to the seventh aspect of the present invention.

The medical device may be an implant selected from the group consisting of hip, knee, shoulder, spine, foot, toe, ankle or dental implants.

The powders may be injected simultaneously or sequentially into the plasma torch without pre-mixing. By not pre-mixing small and coarse particles the plasma-spray coating and its properties may be varied over a much broader range compared to pre-mixed powders. Through this in-situ mixing the ratio between injected powders can be varied independently. Moreover, new coating properties can be easily developed out of commercially available standard powders. One of the risks with pre-mixed powders containing a wide range of particle sizes is de-mixing in the storage container due to vibration or movement/transport of the container leading subsequently to inhomogeneous and irreproducible properties of the resulting plasma-spray coating.

Not only may the size distribution of the powders be varied, but also the chemical composition may be varied. One fraction (e.g. smaller particle) may have a modified chemical composition such that the melting temperature of the particles is reduced while the coarse particles remain chemically unmodified. This may result in optimized cohesion within the plasma-spray coating without changing the microstructure of the coarse particles.

A further possibility may be the simultaneous spraying of bio-resorbable and bio-inert materials (e. g. titanium and calcium phosphates such as brushite) with the possibility that the bio-resorbable fraction contains an antimicrobial constituent (for example silver or zinc). Moreover the bioresorbable fraction may contain additives which facilitate osteointegration, such as strontium, magnesium or fluoride. Any substrate already used to put conventional VPS titanium coatings on its surface is suitable.

### EXAMPLES

The following examples are in accordance with some aspects of the present invention.

### Example 1

Vacuum plasma-spraying is used to prepare open-porous titanium coatings. Two powders with different particle size distributions are injected into the plasma torch simultaneously. The fine powder has a size distribution of 75-180 μm, and the coarse powder has a size distribution of 200-350 μm. The feed rate ratio (mass/mass) between fine and coarse powder is fixed at 3 resulting in porosities of 40 to 70% and average pore sizes of >100 μm. The coating thickness produced is in the range of 500 to 1500 μm. A plasma gas a mixture of argon and helium is used. In the plasma torch, a cylindrical 8 mm-nozzle is used.

### Example 2

The same process as Example 1, with the additional step of applying a transfer arc between the substrate and the plasma torch (DC current: 50 A) to improve the mechanical integrity of the open-porous coating during the spray process.

For the known Si-alloyed titanium powders, it is beneficial to apply a transfer arc (electric current) during the plasma-spray process in order to improve the cohesion of the deposited particle by resistive heating. This electric arc is produced between the substrate and a counter electrode, i. e. plasma torch. The heating effect of the electric current applied through the electric arc is more pronounced at the sinter necks between the already deposited particles due to the minimal material cross section in the sinter necks. The heat-activated diffusion within the metal particles leads to a strengthening of the interface between the particles ideally converting the interface into grain boundary-like structures. For the two-powder approach of the present invention, it has been shown that the arc improves the integrity (Mechanical strength) of these new coatings as well. The combination of the two-powder approach with the transfer arc optimises the properties of the open-porous titanium coatings.

The invention provides a three-dimensional open-porous structure on metal implant materials. The coating provides three key-properties: micro-roughness for bone tissue stimulation, macro-roughness for tissue/implant interlocking and the appropriate thickness for an integration zone.

It is important to note that the two- or more powder approach is not restricted to open-porous titanium coatings but includes new and bioactive coatings formed from alternative materials as disclosed above.

None of the prior art discloses the use of two or more different powders in the plasma-spray process for the production of an open-porous plasma-spray coating. An important advantage of the proposed invention is a significant cost reduction for the production of an open-porous coating compared to the prior art. There is no need for mechanical alloying of the titanium powder with a sinter agent, such as silicon. Standard, commercially available titanium powders can be used for the proposed invention. Moreover, due to the fact that no sinter agent is used in the proposed invention, registration of a new product becomes straightforward since the chemical composition of the final coating closely resembles that of the constituent powders (e.g. commercially pure titanium powders would produce a coating that complies with ASTM F1537). Furthermore, unlike known processes/coatings, there is no risk of contamination of the coating with a basic polymer or inorganic scaffold used for creating the 3D structure (see page 1).

In order to simplify known processes, reduce costs and potential registration procedures, the present invention improves the VPS process such that the sinter aid (for example silicon) becomes obsolete. In accordance with embodiments of the present invention; smaller particles melt completely in the plasma while bigger particles may remain solid. The small, completely fused particles in the powder play a crucial role in the formation of interconnections between the coarser particles. Those small and fused particles act as “glue” for the larger, only partly fused particles. The degree of melting of a particle depends on the particle size since they reside in the plasma for only a very limited time period. Depending on the velocity and the temperature of the plasma torch the heat transferred is not sufficient to fuse a large particle.

What is claimed is:

1. A plasma spray process, comprising the following steps:
providing a first material; providing a second material; providing a plasma source; and introducing the first and second materials into the plasma source in order to produce a plasma spray, wherein the second material at least partially melts in the plasma and binds the first material.

2. A process according to claim 1, wherein the second material fully melts in the plasma.

3. A process according to claim 1, wherein the first material partially melts in the plasma.

4. A process according to claim 1, wherein the first material does not melt in the plasma.

5. A process according to claim 1, comprising more than two materials.

6. A process according to claim 5, wherein at least one of the materials at least partially melts in the plasma and binds at least one of the other materials.

7. A process according to claim 6, wherein at least one of the materials fully melts in the plasma and binds at least one of the other materials.

8. A process according to any preceding dam, wherein at least one of the materials comprise discrete particles.

9. A process according to claim 1, wherein at least one of the materials is a powder.

10. -17. (canceled)

18. A plasma spray process, comprising the following steps:
providing a first powder fraction having a first particle size distribution; providing a second powder fraction having a second particle size distribution; providing a plasma source; and introducing the first and second powder fractions into the plasma in order to generate a plasma spray, wherein the first particle size distribution is greater than the second particle size distribution.

19. A plasma spray process, cornprisina the following steps:
providing a first powder fraction having a first particle size distribution; providing a second powder fraction having a second particle size distribution; providing a plasma source; and introducing the first and second powder fractions into the plasma in order to generate a plasma spray, wherein the mean particle size of the first powder is greater than the mean particle, size of the second powder.

20. A process according to claim 1, further comprising the steps: providing a substrate; and exposing the substrate to the plasma spray in order to form an open porous structure on the substrate.

21. A process according to dam 20, wherein the substrate is selected from the group consisting of metal, metal alloy, ceramic, polymer, or combinations thereof.

22. A process according to dam 20, wherein the substrate is selected from the group consisting of titanium, titanium alloy, cobalt chromium alloy, zirconium, zirconium alloy, magnesium, magnesium alloy, tantalum, tantalum alloy, hafnium, hafnium alloy, niobium, niobium alloy, stainless steel, ultra-high molecular weight polyethylene (UHMWPE), polyaryletheretherketone (PEEK), polyaryletherketone (PAEK), polyetherketoneketone (PEKK), or combinations thereof,

23. A process according to claim 20, further comprising the step of applying a transfer arc between the substrate and the plasma source.

24. A process according to claim 20, further comprising the step of applying an intermediate layer between the substrate and the open porous structure.

25. A process according to claim 24, wherein the intermediate layer comprises a material selected from the group consisting of titanium, titanium alloy, cobalt chromium alloy, zirconium, zirconium alloy, magnesium, magnesium alloy, stainless steel, ultra-hiah molecular weight polyethylene (UHMWPE), polyaryletheretherketone (PEEK), polyetherketoneketone (PEKK), or combinations thereof.

26. A process according to claim 9, wherein the first powder comprises coarse particles and the second powder comprises fine particles.

27. A process according to claim 18, wherein the first powder particle size distribution is in the range 150-800 μm.

28. A process according to claim 18, wherein the first powder particle size distribution is in the range 180-500 μm.

29. A process according to claim 18, wherein the first powder particle size distribution is in the range 200-350 μm.

30. A process according to claim 18, wherein the second powder particle size distribution is in the range 30-250 μm.

31. A process according to claim 18, wherein the second powder particle size distribution is in the range 45-200 μm.

32. A process according to claim 18, wherein the second powder particle size distribution is in the range 75-200 μm.

33. A process according to claim 10, comprising more than two powders.

34. A process according to dam 33, wherein at least two of the powders have a different particle size distribution.

35. A process according to claim 33, wherein each powder has a different particle size distribution.

36. A process according to claim 19, wherein at least two of the powders or materials have a different chemical composition.

37. A process according to claim 19, wherein the powders or materials are selected from the group consisting of metal, metal ahoy, ceramic, polymer, or combinations thereof.

38. A process according to claim 19, wherein the powders or materials are selected from the group consisting of titanium, tantalum, hafnium, niobium, zirconium, magnesium, zinc, or alloys or combinations thereof.

39. A process according to claim 19, wherein at least two of the powders or materials are introduced simultaneously.

40. A process according to claim 19, wherein at least two of the powders or materials are introduced sequentially.

41. A process according to claim 19, wherein the plasma source is a plasma torch,

42. A process according to claim 19, wherein the plasma spray process occurs in vacuum.

43. A process according to claim 1, wherein the plasma spray process occurs in an inert atmosphere.

44. A process according to claim 43, wherein the inert atmosphere comprises argon.

45. A process according to claim 43, wherein the inert atmosphere comprises helium.

46. A process according to claim 43, wherein the inert atmosphere comprises nitrogen.

47. A process according to claim 43, wherein the chamber pressure is in the range 400 mbar-atmospheric pressure.

48. A process according to claim 47, wherein the chamber pressure is in the range 500 mbar-atmospheric.

49. A process according to claim 47, wherein the chamber pressure is in the range 500-800 mbar.

50. A process according to claim 47, wherein the chamber pressure is in the range 550-750 mbar.

51. A process according to claim 1, wherein the plasma forming gases are selected from the group consisting of argon, helium, hydrogen, nitrogen, or combinations thereof.

52. A process according to claim 51, wherein the plasma forming gases comprise argon and helium having a flow rate in the range 40-80 l/min.

53. A process according to claim 51, wherein the plasma forming gases comprise argon and helium and the argon/helium ratio is in the range 0.6-0.8 for the plasma gas.

54. A process according to claim 1, wherein the powders or materials are introduced into the plasma by a carrier gas.

55. A process according to claim 54, wherein the different powders or materials are introduced into the plasma by different carrier gases.

56. A process according to claim 54, wherein the carrier gas flow rates are different for the different powders or materials.

57. A process according to claim 1, further comprising the step of mixing the materials or powders in situ prior to their introduction into the plasma.

58. A process according to claim 1, further comprising a device disposed in the powder feed lines to pulse the powder flow.

59. A process according to claim 20, wherein at least one of the powders or materials is electrically conductive and an arc is generated between the substrate and a counter electrode.

60. A process according to claim 59, wherein the transfer arc current is in the range 0-200 A.

61. A process according to claim 1, wherein the plasma generating current is in the range 900-1300 A.

62. A process according to claim 26, wherein the ratio between coarse and fine powder is in the range 1/4-1/2.

63. (canceled)

64. (canceled)

65. (canceled)

66. A substrate modified by a process defined by claim 20.

67. (canceled)

68. A medical device comprising a substrate according to claim 66.

69. A medical device according to claim 68, wherein the medical device is an implant selected from the group consisting of hip, knee, shoulder, spine, foot, toe, ankle, or dental implants.
